(19) United States
(12) Patent Application Publication
(10) Pub. No.: US 2013/0029698 A1
(43) Pub. Date: Jan. 31, 2013

(54) WIRELESS TERMINAL DEVICE AND COMMUNICATION CONTROL METHOD

(71) Applicant: Naoto Higashide, Kanagawa (JP)

(72) Inventor: Naoto Higashide, Kanagawa (JP)

(73) Assignee: KYOCERA CORPORATION, Kyoto (JP)

(21) Appl. No.: 13/558,509

(22) Filed: Jul. 26, 2012

(30) Foreign Application Priority Data
Jul. 26, 2011 (JP) 2011-162936
Jul. 25, 2012 (JP) 2012-164615

(51) Int. Cl. H04W 36/34; H04W 4/14

(52) U.S. Cl. 455/466; 455/552.1

(57) ABSTRACT

A mobile telephone device that selectively switches an LTE communication system that provides a first service and a CDMA communication system that provides a second service for performing communication, includes: a first timer management unit which, after transferring from the LTE communication system to the CDMA communication system and ending communication related to the second service, activates a first timer and detects elapse of the first timer; and a switching unit which switches from the CDMA communication system to the LTE communication system in response to the elapse of the first timer being detected; wherein after ending the communication related to the second service, the first timer management unit changes timing to start the first timer or length of the first timer according to an ending reason of the communication.

This application is based on and claims the benefit of priority from Japanese Patent Application Nos. 2011-162936 and 2012-164615, respectively filed on 26 Jul. 2011 and filed on 25 Jul. 2012, the content of which is incorporated herein by reference.

### BACKGROUND OF THE INVENTION

1. Field of the Invention

The present invention relates to a wireless terminal device and a communication control method that selectively switch among a plurality of communication systems for performing communication.

2. Related Art

In recent years, LTE (Long Term Evolution) type communication systems have been introduced as communication systems used by wireless terminal devices such as a mobile telephone device, in addition to Circuit Switched (CS) type communication systems (for example, CDMA).

In addition, a CS Fallback function has been defined in 3GPP TS 23.272. With this function, it is possible to notify in an LTE communication system an incoming call request from a CDMA communication system (For example, refer to 3GPP TS 23.272 V10.3.1, “Circuit Switched (CS) fallback in Evolved Packet System (EPS); Stage 2” 2011-04).

In addition, a technique is proposed which, when a voice call is completed after performing handover to an CDMA communication system, performs handover to an LTE communication system again, which is given priority over the CDMA communication system (for example, refer to JP2010-147576A).

### SUMMARY OF THE INVENTION

An object of the present invention is to provide a wireless terminal device and a communication control method that can switch communication systems efficiently.

A wireless terminal device according to the invention is a wireless terminal device that selectively switches a first communication system that provides a first service and a second communication system that provides a second service for performing communication, including: a first timer management unit which, after transferring from the first communication system to the second communication system and ending communication related to the second service, activates a first timer and detects elapse of the first timer; and a switching unit which switches from the second communication system to the first communication system in response to the elapse of the first timer being detected by the first timer management unit; wherein after ending the communication related to the second service, the first timer management unit changes timing to start the first timer or length of the first timer according to an ending reason of the communication.

In addition, it is preferable if, in a case where it is determined that the ending reason is failure of outgoing voice call, the first timer management unit delays timing to start the first timer or extends time until elapse of the first timer.

In addition, it is preferable if, in a case where it is determined that the ending reason is failure of response to incoming voice call, the first timer management unit delays timing to start the first timer or extends time until elapse of the first timer.

In addition, it is preferable if, in a case where it is determined that the ending reason is failure of SMS reception, the first timer management unit delays timing to start the first timer or extends time until elapse of the first timer.

In addition, it is preferable if, in a case where it is determined that the ending reason is failure of SMS reception, the first timer management unit delays timing to start the first timer or extends time until elapse of the first timer such that elapsing timing of the first timer is after re-sending timing of SMS from a network side.

In addition, it is preferable if, when time until elapse of the first timer exceeds a predetermined time, the first timer management unit immediately makes the first timer elapse.

In addition, it is preferable if, when a number of successive failures of SMS reception reach a predetermined number, the first timer management unit immediately makes the first timer elapse.

In addition, it is preferable if a wireless terminal device according to the present invention further includes a second timer management unit which, when elapse of the first timer is detected by the first timer management unit and a predetermined application is running, activates a second timer and detects elapse of the second timer, wherein when the second timer is activated, the switching unit switches from the second communication system to the first communication system in accordance with elapse of the second timer being detected by the second timer management unit after elapse of the first timer.

In addition, it is preferable if a wireless terminal device according to the present invention further includes a second timer management unit which, when a predetermined application is running upon communication related to the second service being ended, activates a second timer and detects elapse of the second timer, wherein when the second timer is activated, the first timer management unit activates the first timer after elapse of the second timer or after ending the predetermined application.

In addition, it is preferable if, when an operation input is detected in the predetermined application during when the second timer is activated, the second timer management unit restarts the second timer.

In addition, it is preferable if the predetermined application is an application capable of producing communication related to the second service.

In addition, it is preferable if the first timer management unit activates the first timer when communication in the second communication system is ended after the wireless terminal device is transferred from the first communication system of an LTE type to the second communication system of a CDMA type with a CS-Fallback function defined in 3GPP TS 23.272.

A communication control method according to the present invention is a communication control method of a wireless terminal device that selectively switches a first communication system that provides a first service and a second communication system that provides a second service for performing communication, the method including: a first timer management step which, after transferring from the first communication system to the second communication system and ending communication related to the second service, activates a first timer and detects elapse of the first timer; and a switching step which switches from the second communication system to the first communication system in response to the elapse of the first timer being detected in the first timer management step; wherein after ending the communication related to the second service, timing to start the first timer or length of the first timer is changed in the first timer management step according to an ending reason of the communication.

A wireless terminal device according to the present invention is a wireless terminal device for performing communication with a first communication system or a second communication system, including a control unit which, when a timer elapses after transferring from the first communication system to the second communication system and ending communication by the second communication system, switches from the second communication system to the first communication system, wherein the timer is changed according to a reason why the communication by the second communication system is ended.

According to the present invention, the wireless terminal device can switch communication systems efficiently.

### BRIEF DESCRIPTION OF THE DRAWINGS

FIG. 1 is an external perspective view of a mobile telephone device according to an embodiment of the present invention;

FIG. 2 is a block diagram showing functions of the mobile telephone device according to the embodiment of the present invention;

FIG. 3 is a flow chart showing processing of the mobile telephone device according to the embodiment of the present invention;

FIG. 4 is a flow chart showing a first process branched from FIG. 3; and

FIG. 5 is a flow chart showing a second process branched from FIG. 3.

### DETAILED DESCRIPTION OF THE INVENTION

Hereafter, an example of the embodiment of the present invention will be described. It should be noted that, in the present embodiment, a mobile telephone device 1 will be described as an example of a wireless terminal device.

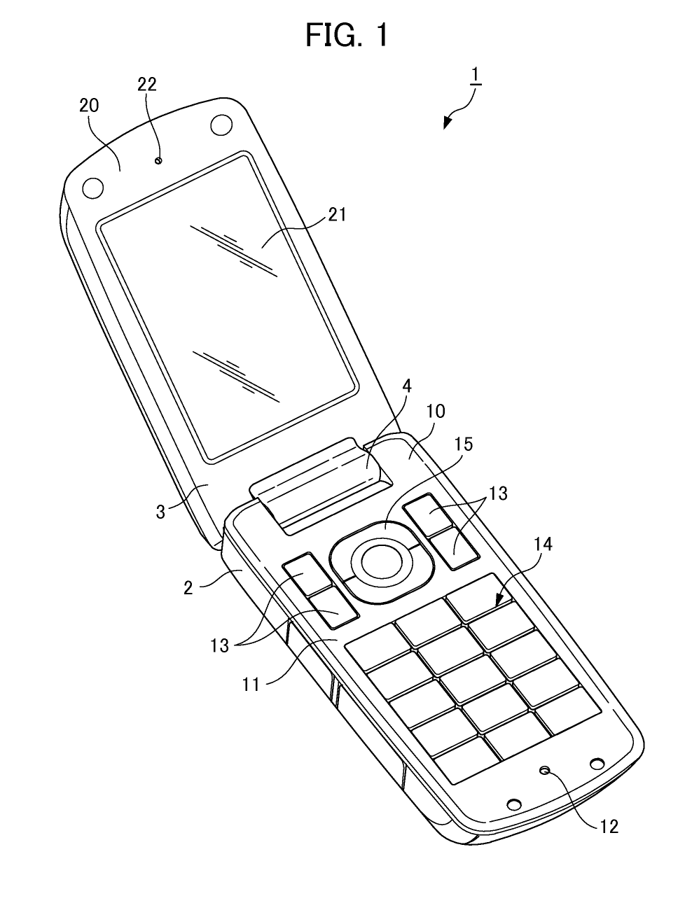

FIG. 1 is an external perspective view of the mobile telephone device 1 according to the present embodiment.

It should be noted that, although FIG. 1 shows an embodiment of a so-called folder type mobile telephone device, the embodiment of the mobile telephone device according to the present invention is not limited thereto. For example, the mobile telephone device may be of: a slider type in which one of the bodies slides to one direction in a state in which the bodies are mutually superimposed; a rotating (turning) type in which one of the bodies is rotated around an axis line along the direction of superimposing the bodies; and a type (straight type) in which an operation unit and a display unit are disposed in one body without having a connecting portion.

The mobile telephone device 1 is configured to include an operation unit side body 2 and a display unit side body 3. The operation unit side body 2 is configured to include, on a surface portion 10 thereof, an operation unit 11 and a microphone 12 to which sound produced by a user of the mobile telephone device 1 is input when the user is having a telephone call or using a speech recognition application. The operation unit 11 is configured to include: function setting operation buttons 13 for activating various functions, such as various setting functions, a phonebook function, an SMS (short message service) function, and an e-mail function; input operation buttons 14 for inputting digits of a telephone number, characters for an e-mail, or the like; and a determination operation button 15 for performing determinations in various operations, scrolling, or the like.

In addition, the display unit side body 3 is configured to include, on the surface portion 20 thereof: a display unit 21 for displaying a variety of information; and a receiver 22 for outputting voice of the other party of the call.

In addition, an upper end of the operation unit side body 2 and a lower end of the display unit side body 3 are interconnected via a hinge mechanism 4. Furthermore, by rotating the operation unit side body 2 and the display unit side body 3 relatively to each other, which are interconnected via the hinge mechanism 4, the mobile telephone device 1 can be in a state where the operation unit side body 2 and the display unit side body 3 are opened with respect to each other (opened state), and a state where the operation unit side body 2 and the display unit side body 3 are folded together (closed state).

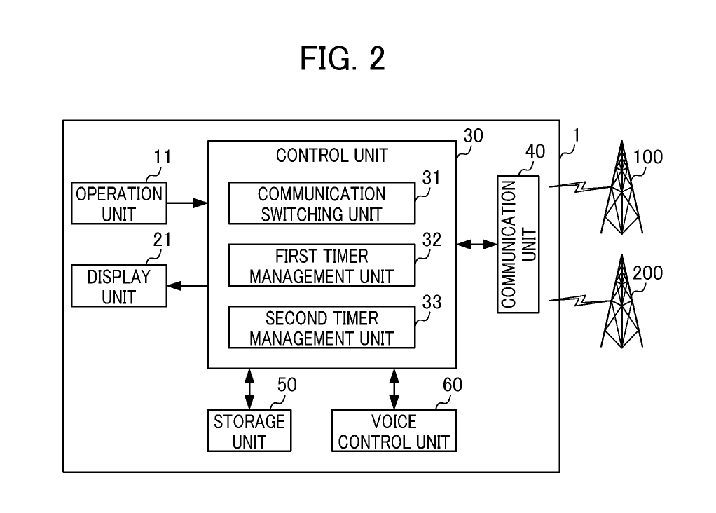

FIG. 2 is a block diagram showing functions of the mobile telephone device 1 according to the present embodiment.

The mobile telephone device 1 includes the operation unit 11, the display unit 21, the control unit 30, the communication unit 40, the storage unit 50, and the voice control unit 60.

The control unit 30 controls the entire mobile telephone device 1, and for example, performs predetermined control over units such as the display unit 21 and the communication unit 40. In addition, the control unit 30 executes a variety of processing by receiving inputs from the operation unit 11, the communication unit 40, or the like. Moreover, upon executing the processing, the control unit 30 controls the storage unit 50, and reads various programs and data and writes data. It should be noted that the detailed functions of the control unit 30 according to the present embodiment will be described later.

The communication unit 40 communicates with an external device (a base station 100 of the LTE communication system or a base station 200 of the CDMA communication system) using a predetermined utilizing frequency band (for example, 2 GHz band and 800 MHz band). Moreover, the communication unit 40 demodulates a signal received from an antenna and supplies the signal thus processed to the control unit 30, and furthermore modulates the signal supplied from the control unit 30 and transmits the signal from the antenna to the external device.

Here, in the present embodiment, since the communication unit 40 conforms to both W-CDMA or CDMA2000_{—}1x, which is a communication protocol for voice and data communications (hereinafter “CDMA”), and LTE, which is a communication protocol mainly used for high speed data communication, it is possible to communicate with a communication system of either one of the protocols. The communication unit 40 communicates with the base station with any one of the protocols by selectively switching among a plurality of communication systems, which provide mutually overlapping communication areas based on an instruction from the control unit 30. It should be noted that, the mobile telephone device 1 gives priority to communication using an LTE communication system of an LTE type (first communication system) at the time of data communication (first service), and switches to communication using a CDMA communication system of a CDMA type (second communication system) at the time of a voice call or transmission and reception of SMS (second service).

It should be noted that SMS is a function for transmitting and receiving a short message (about several tens of characters) to and from a communication counterpart. This SMS uses communication outgoing and incoming sequences, which are partly in common with voice communication, and a transmission counterpart is identified with a telephone number in the CDMA communication system.

The storage unit 50 includes a working memory, for example, and is used for arithmetic processing by the control unit 30. In addition, the storage unit 50 stores, for example, timer setting information, which will be described later, in addition to various programs in accordance with the present embodiment.

The voice control unit 60 performs predetermined voice processing on a signal supplied from the communication unit 40 according to the control of the control unit 30, and outputs to the receiver 22 the signal thus processed. The receiver 22 externally outputs the signal transmitted from the voice control unit 60. It should be noted that this signal may be outputted from a loudspeaker, in place of the receiver 22 or in addition to the receiver 22. In addition, the voice control unit 60 processes the signal inputted from the microphone 12 according to the control of the control unit 30, and outputs to the communication unit 40 the signal thus processed. The communication unit 40 performs predetermined processing on a signal transmitted from the voice control unit 60 and outputs the signal thus processed from the antenna.

Next, the function of the control unit 30 and control devices of each communication system will be described in detail.

The control unit 30 includes a communication switching unit 31, a first timer management unit 32, and a second timer management unit 33.

The communication switching unit 31 gives instructions to the communication unit 40 by selectively switching an LTE communication system and a CDMA communication system.

Specifically, when performing a voice call or transmitting and receiving SMS, the communication switching unit 31 switches to the CDMA communication system using the CS Fallback function.

In addition, after ending communication in a CDMA communication system, in a case where elapse in a first timer, which will be described later, is detected by the first timer management unit 32 and a second timer, which will be described later, does not become active, the communication switching unit 31 switches the communication from the CDMA communication system to an LTE communication system.

At this time, in a case where the second timer has become active, the communication switching unit 31 switches the communication from the CDMA communication system to the LTE communication system in accordance with elapse of the second timer being detected by the second timer management unit 33 after the elapse of the first timer.

After transferring from the LTE communication system to the CDMA communication system and ending communication related to the second service, the first timer management unit 32 activates the first timer and detects elapse of the first timer.

In addition, after ending the communication related to the second service, the first timer management unit 32 changes timing to start the first timer or time until elapse of the first timer according to the ending reason of the communication. It is assumed that the time until elapse is changed in the descriptions below. Specifically, the first timer management unit 32 selectively sets four kinds, which are an ordinary timer, an outgoing call timer, an incoming call timer, and an SMS timer.

When succeeding in an outgoing voice call, an incoming voice call, or an SMS reception after transferring to a CDMA communication system with the CS Fallback function, the first timer management unit 32 sets the ordinary timer.

Meanwhile, when failing in an outgoing voice call, a response to an incoming voice call, or an SMS reception after transferring to the CDMA communication system with the CS Fallback function, the first timer management unit 32 sets the outgoing call timer, the incoming call timer, or the SMS timer, respectively, which are longer than the ordinary timer.

Here, when the mobile telephone device 1 has failed to receive an SMS, the base station 200 may be configured to re-send after elapsing a predetermined time period (for example, 10 seconds, 30 seconds, 60 seconds, 180 seconds, . . . ) from the failure in accordance with the number of times of successive failures.

In this case, if it is determined that the ending reason is failure of SMS reception, the first timer management unit 32 delays the timing to start the SMS timer or extends the time until elapse of the SMS timer such that the elapsing timing of the SMS timer is after the re-sending timing of SMS from the network side. Specifically, as the number of failures of SMS reception increases like one, two, . . . , the first timer management unit 32 increases the time until elapse of the SMS timer like 15 seconds, 35 seconds, . . . .

Furthermore, when the time until elapse of the SMS timer exceeds a predetermined time, the first timer management unit 32 immediately makes the first timer elapse. For example, when the time until the elapse exceeds 60 seconds, that is, when failures of SMS reception have continued three times, the first timer management unit 32 makes the first timer elapse without setting the SMS timer.

When a predetermined application is being executed upon elapse of the first timer being detected by the first timer management unit 32, the second timer management unit 33 activates a during-launch timer, which serves as the second timer, and detects elapse of the during-launch timer.

In addition, when an operation input is detected in the predetermined application during when the second timer is activated, the second timer management unit 33 restarts the second timer.

Here, a predetermined application is an application from which occurrence of outgoing and incoming voice call or SMS transmission and reception is expected and examples of the predetermined application include address book, outgoing call history, SMS incoming box, and SMS creation screen.

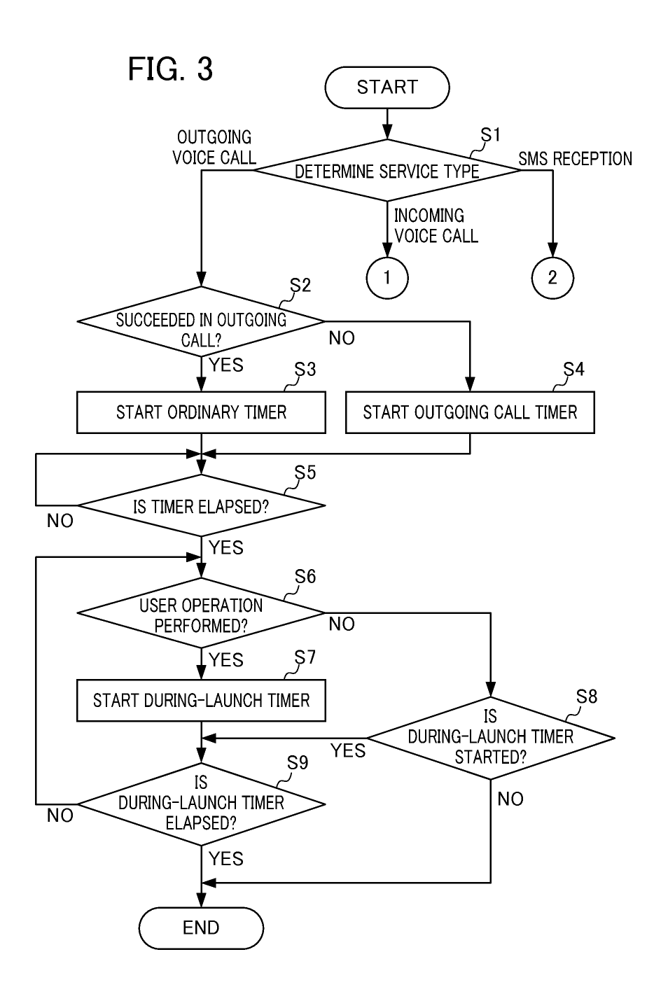

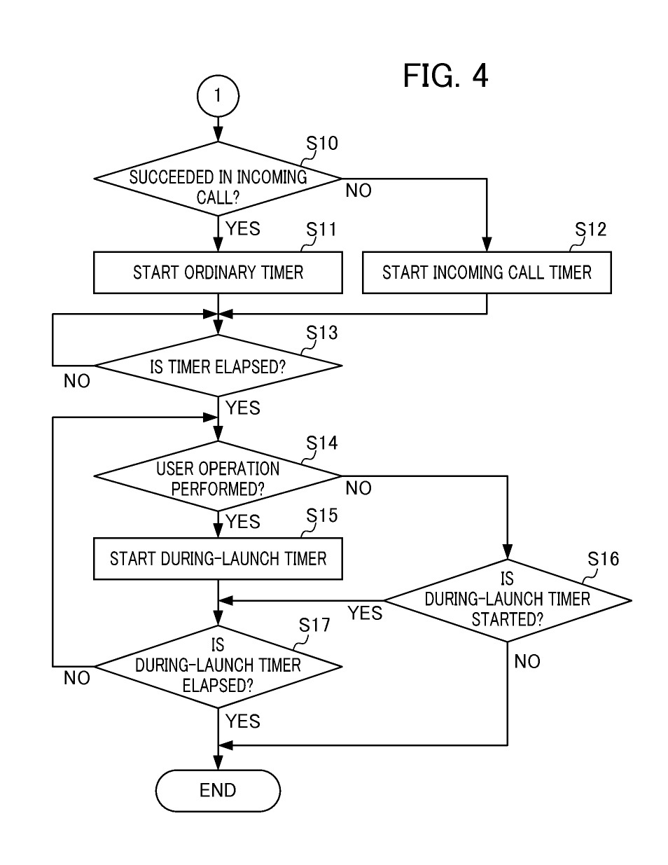

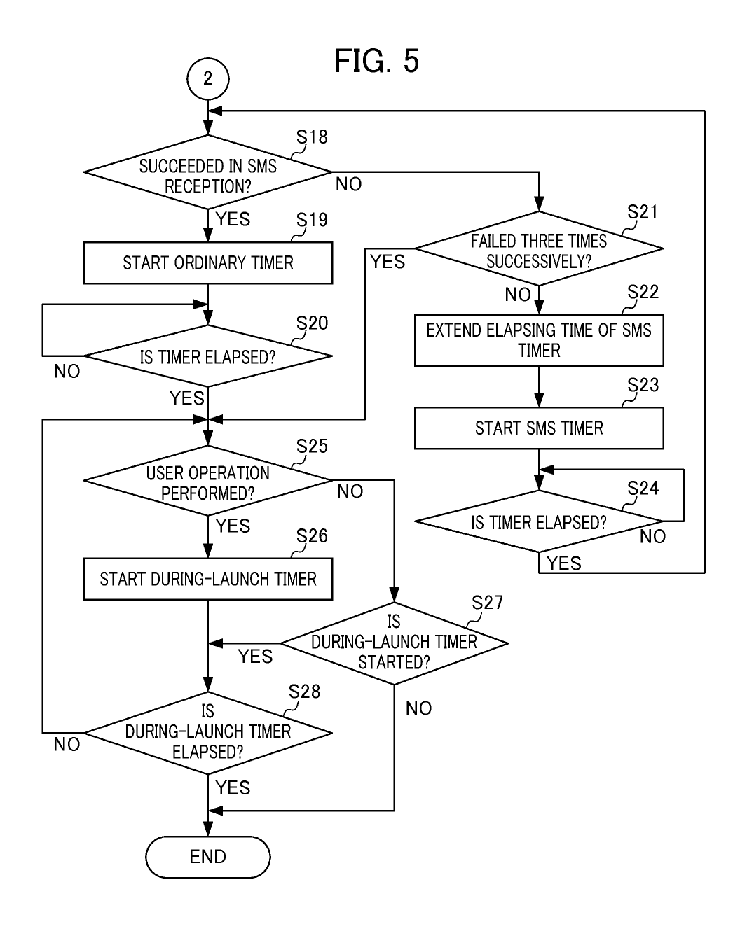

FIGS. 3, 4 and 5 are flow charts showing waiting processing from when the mobile telephone device 1 according to the present embodiment ends communication related to the second service in a CDMA communication system until scanning of the LTE communication system is started.

In Step S1, the control unit 30 determines the type of the second service. If the determined type is outgoing voice call, the process proceeds to Step S2. If the determined type is incoming voice call, the process proceeds to Step S10. In addition, if the determined type is SMS reception, the process proceeds to Step S18.

In Step S2, the control unit 30 determines whether or not the outgoing voice call has succeeded. If the determination is YES, the process proceeds to Step S3, and if the determination is NO, the process proceeds to Step S4.

In Step S3, the control unit 30 (first timer management unit 32) starts the ordinary timer as the first timer.

In Step S4, the control unit 30 (first timer management unit 32) starts the outgoing call timer as the first timer.

In Step S5, the control unit 30 (first timer management unit 32) determines whether or not the first timer has elapsed. If the determination is YES, the process proceeds to Step S6, and if the determination is NO, the process repeats Step S5.

In Step S6, the control unit 30 determines whether or not the predetermined application is running and a user operation has been performed. If the determination is YES, the process proceeds to Step S7, and if the determination is NO, the process proceeds to Step S8.

In Step S7, the control unit 30 (second timer management unit 33) starts the during-launch timer as the second timer.

In Step S8, the control unit 30 (second timer management unit 33) determines whether or not the during-launch timer has been started. If the determination is YES, the process proceeds to Step S9. Meanwhile, if the determination is NO, the process ends and scanning of the LTE communication system is started by the communication switching unit 31.

In Step S9, the control unit 30 (second timer management unit 33) determines whether or not the during-launch timer has elapsed. If the determination is YES, the process ends and scanning of the LTE communication system is started by the communication switching unit 31. Meanwhile, if the determination is NO, the process returns to Step S6.

In Step S10, the control unit 30 determines whether or not the incoming voice call has succeeded. If the determination is YES, the process proceeds to Step S11, and if the determination is NO, the process proceeds to Step S12.

In Step S11, the control unit 30 (first timer management unit 32) starts the ordinary timer as the first timer.

In Step S12, the control unit 30 (first timer management unit 32) starts the incoming call timer as the first timer.

In Step S13, the control unit 30 (first timer management unit 32) determines whether or not the first timer has elapsed. If the determination is YES, the process proceeds to Step S14, and if the determination is NO, the process repeats Step S13.

In Step S14, the control unit 30 determines whether or not the predetermined application is running and a user operation has been performed. If the determination is YES, the process proceeds to Step S15, and if the determination is NO, the process proceeds to Step S16.

In Step S15, the control unit 30 (second timer management unit 33) starts the during-launch timer as the second timer.

In Step S16, the control unit 30 (second timer management unit 33) determines whether or not the during-launch timer has been started. If the determination is YES, the process proceeds to Step S17. Meanwhile, if the determination is NO, the process ends and scanning of the LTE communication system is started by the communication switching unit 31.

In Step S17, the control unit 30 (second timer management unit 33) determines whether or not the during-launch timer has elapsed. If the determination is YES, the process ends and scanning of the LTE communication system is started by the communication switching unit 31. Meanwhile, if the determination is NO, the process returns to Step S14.

In Step S18, the control unit 30 determines whether or not the SMS reception has succeeded. If the determination is YES, the process proceeds to Step S19, and if the determination is NO, the process proceeds to Step S21.

In Step S19, the control unit 30 (first timer management unit 32) starts the ordinary timer as the first timer.

In Step S20, the control unit 30 (first timer management unit 32) determines whether or not the first timer has elapsed. If the determination is YES, the process proceeds to Step S25, and if the determination is NO, the process repeats Step S20.

In Step S21, the control unit 30 determines whether or not the SMS reception has successively failed three times. If the determination is YES, the process proceeds to Step S25, and if the determination is NO, the process proceeds to Step S22.

In Step S22, the control unit 30 (first timer management unit 32) extends the elapsing time of the SMS timer according to the number of times of successive failures of the SMS reception.

In Step S23, the control unit 30 (first timer management unit 32) starts the SMS timer as the first timer.

In Step S24, the control unit 30 (first timer management unit 32) determines whether or not the first timer has elapsed. If the determination is YES, the process returns to Step S18, and if the determination is NO, the process repeats Step S24.

In Step S25, the control unit 30 determines whether or not the predetermined application is running and a user operation has been performed. If the determination is YES, the process proceeds to Step S26, and if the determination is NO, the process proceeds to Step S27.

In Step S26, the control unit 30 (second timer management unit 33) starts the during-launch timer as the second timer.

In Step S27, the control unit 30 (second timer management unit 33) determines whether or not the during-launch timer has been started. If the determination is YES, the process proceeds to Step S28. Meanwhile, if the determination is NO, the process ends and scanning of the LTE communication system is started by the communication switching unit 31.

In Step S28, the control unit 30 (second timer management unit 33) determines whether or not the during-launch timer has elapsed. If the determination is YES, the process ends and scanning of the LTE communication system is started by the communication switching unit 31. Meanwhile, if the determination is NO, the process returns to Step S25.

As described above, in accordance with the present embodiment, the mobile telephone device 1 can change the waiting time until the LTE communication system is scanned according to the ending reason after transferring to the CDMA communication system with the CS Fallback function and ending the communication related to the second service. Accordingly, the mobile telephone device 1 can perform switching of the communication systems efficiently by suppressing frequent occurrence of the switching to the CDMA communication system with the CS Fallback function.

Specifically, if it is determined that outgoing voice call has failed, a reply to incoming voice call has failed, or SMS reception has failed, the mobile telephone device 1 can make the waiting time until the LTE communication system is scanned different from each other. Accordingly, the mobile phone 1 can set the waiting time as appropriate according to the type of the service.

In addition, since the waiting time can be set in accordance with the re-sending timing if it is determined that the ending reason of the communication is the failure of SMS reception, the mobile telephone device 1 can perform switching of the communication systems efficiently by preventing the waiting time from extending wastefully.

Furthermore, since the first timer elapses immediately if the waiting time set at this time exceeds a predetermined time, that is, if the number of successive failures have reached a predetermined number, the switching of the communication systems can be performed efficiently by preventing the waiting time from extending wastefully.

In addition, even in a case where the first timer has elapsed, if a predetermined application is running or a user operation is continuing at this time, a second timer is activated furthermore. Accordingly, since it is possible to determine the possibility that communication relating to the second service takes place continuously and extend the waiting time until the LTE communication system is scanned, the mobile telephone device 1 can switch the communication system efficiently.

Furthermore, since the second timer is restarted when a user operation is detected, the mobile telephone device 1 can extend the waiting time by predicting occurrence of the communication and thus it is possible to switch the communication systems efficiently.

Although the embodiments of the present invention have been described in the above, the present invention is not limited to the embodiments described above. In addition, the effects described for the embodiments of the present invention are merely a result of exemplifying effects arising from the present invention, and the effects of the present invention are not limited to those described for the embodiments of the present invention.

The start of the first timer in the above embodiment may be taken place after the during-launch timer has elapsed, or after an end of a predetermined application.

In addition, if it is determined in Step S21 that SMS reception has failed three times continuously (YES), the control unit 30 (first timer management unit 32) may start the ordinary timer by moving to Step S19.

The first communication system is not limited to that of an LTE type, and may be of, a WiMAX type or the like as long as it is a type of communication that does not have a routine of outgoing and incoming voice call, a routine of SMS transmission and reception or the like, and the present invention is applicable as long as a function corresponding to CS Fallback can be implemented.

In addition, the wireless terminal device according to the present invention is not limited to a mobile telephone device 1. The present invention is applicable to various devices, such as a PHS (trademark: Personal Handyphone System), a PDA (Personal Digital Assistant), a gaming device, a navigation device, a personal computer, and a communication-dedicated module specialized in communication functions.

What is claimed is:

1. A wireless terminal device that selectively switches a first communication system that provides a first service and a second communication system that provides a second service for performing communication, comprising:
a first timer management unit which, after transferring from the first communication system to the second communication system and ending communication related to the second service, activates a first timer and detects elapse of the first timer; and
a switching unit which switches from the second communication system to the first communication system in response to the elapse of the first timer being detected by the first timer management unit; wherein
after ending the communication related to the second service, the first timer management unit changes timing to start the first timer or length of the first timer according to an ending reason of the communication.

2. The wireless terminal device according to claim 1, wherein
if it is determined that the ending reason is failure of outgoing voice call, the first timer management unit delays timing to start the first timer or extends time until elapse of the first timer.

3. The wireless terminal device according to claim 1, wherein
if it is determined that the ending reason is failure of response to incoming voice call, the first timer management unit delays timing to start the first timer or extends time until elapse of the first timer.

4. The wireless terminal device according to claim 1, wherein
if it is determined that the ending reason is failure of SMS reception, the first timer management unit delays timing to start the first timer or extends time until elapse of the first timer.

5. The wireless terminal device according to claim 4, wherein
if it is determined that the ending reason is failure of SMS reception, the first timer management unit delays timing to start the first timer or extends time until elapse of the first timer such that elapsing timing of the first timer is after re-sending timing of SMS from a network side.

6. The wireless terminal device according to claim 5, wherein
when time until elapse of the first timer exceeds a predetermined time, the first timer management unit immediately makes the first timer elapse.

7. The wireless terminal device according to claim 5, wherein
when a number of successive failures of SMS reception reach a predetermined number, the first timer management unit immediately makes the first timer elapse.

8. The wireless terminal device according to claim 1, further comprising
a second timer management unit which, when elapse of the first timer is detected by the first timer management unit and a predetermined application is running, activates a second timer and detects elapse of the second timer, wherein
when the second timer is activated, the switching unit switches from the second communication system to the first communication system in accordance with elapse of the second timer being detected by the second timer management unit after elapse of the first timer.

9. The wireless terminal device according to claim 8, wherein
when an operation input is detected in the predetermined application during when the second timer is activated, the second timer management unit restarts the second timer.

10. The wireless terminal device according to claim 8, wherein
the predetermined application is an application capable of producing communication related to the second service.

11. The wireless terminal device according to claim 1, further comprising
a second timer management unit which, when a predetermined application is running upon communication related to the second service being ended, activates a second timer and detects elapse of the second timer, wherein
when the second timer is activated, the first timer management unit activates the first timer after elapse of the second timer or after ending the predetermined application.

12. The wireless terminal device according to claim 11, wherein
when an operation input is detected in the predetermined application during when the second timer is activated, the second timer management unit restarts the second timer.

13. The wireless terminal device according to claim 11, wherein
the predetermined application is an application capable of producing communication related to the second service.

14. The wireless terminal device according to claim 1, wherein
the first timer management unit activates the first timer when communication in the second communication system is ended after the wireless terminal device is transferred from the first communication system of an LTE type to the second communication system of a CDMA type with a CS-Fallback function defined in 3GPP TS 23.272.

15. A communication control method of a wireless terminal device that selectively switches a first communication system that provides a first service and a second communication system that provides a second service for performing communication, the method comprising:
a first timer management step which, after transferring from the first communication system to the second communication system and ending communication related to the second service, activates a first timer and detects elapse of the first timer; and
a switching step which switches from the second communication system to the first communication system in response to the elapse of the first timer being detected in the first timer management step; wherein
after ending the communication related to the second service, timing to start the first timer or length of the first timer is changed in the first timer management step according to an ending reason of the communication.

16. A wireless terminal device for performing communication with a first communication system or a second communication system, comprising
a control unit which, when a timer elapses after transferring from the first communication system to the second communication system and ending communication by the second communication system, switches from the second communication system to the first communication system, wherein
the timer is changed according to a reason why the communication by the second communication system is ended.
